(19) United States
(12) Patent Application Publication
(10) Pub. No.: US 2007/0239608 A1
(43) Pub. Date: Oct. 11, 2007

(54) Digital media distribution system

(75) Inventor: Christopher R. Elbring, St. Louis, MO (US)

Correspondence Address: CROWELL & MORING LLP;INTELLECTUAL PROPERTY GROUP, P.O. BOX 14300, WASHINGTON, DC, 20044-4300, US

(73) Assignee: Veriplay LLC, St. Louis, MO (US)

(21) Appl. No.: 11/386,708

(22) Filed: Mar. 23, 2006

(51) Int. Cl. H04L 9/00

(52) U.S. Cl. 705/51

(57) ABSTRACT

The present invention relates to the distribution of digital media. In particular, the present invention relates to portable devices that facilitate and control the distribution of digital media.

### FIELD OF THE INVENTION

The present invention relates to the distribution of digital media. In particular, the present invention relates to portable devices and systems that facilitate and control the distribution of digital media.

### BACKGROUND OF THE INVENTION

Historically, distribution of digital media has relied on individual components containing the media, a 3rd party media player and a distribution device (e.g. DVD, CD, etc.) which combine to create a system for playing the file. This method of media distribution has resulted in a number of problems that distributors of content continually attempt to address:

1. Piracy

2. Cost of Distribution

3. Universality

4. Integration

Piracy (illegal copying of digital media) is the largest of these problems. The reason for this is that digital media allows for the quick and easy creation of copies that are identical in all aspects to the original. No widely adopted solution exists today to stop people with limited technical knowledge from making perfect copies of digital content and selling it at a steep discount to the original. Cost of distribution is also a major problem for deploying content as single use media per copy costs are very high (i.e. the cost of the deployment media is almost the same cost as the content on it) and security is typically low (generic, non-secure 3rd party systems are used for playing the content). Universality is also important to distributors as the media they use must be compatible with a large universe of devices. Current single-use media is not universal and requires specialized, expensive physical connections to play the media content (such as a DVD player). Integration is also a key component of a digital media deployment system. Current deployment methods rely on 3rd party hardware and software to function. This reliance creates security problems as the system is only as secure as the weakest link. Further, these non-integrated systems require the digital content to leave the media and effectively be copied to a 3rd party device, computer or video system in order to be played. Current digital media distribution systems include such products as Apple iPod Video and TIVO Software Player. While these products offer some advantages they do not address the above problems that continue to vex developers of digital media distribution systems.

The use of USB-based memory devices is well known in the art. U.S. Pat. No. 6,986,030 discloses a portable memory device in which the software on the portable memory device will automatically execute after the host computing device recognizes the presence of the portable device. The device disclosed in U.S. Pat. No. 6,986,030 does not contain digital media for distribution; it merely contains information relating to the configuration information for a program on a host computing device. Further, the portable memory device disclosed in U.S. Pat. No. 6,986,030 lacks a means of tying the data on the memory device, the media player, and the memory device together thereby providing a secure means of distributing digital data. As such, the device of U.S. Pat. No. 6,986,030 fails to cure the problems associated with current digital media distribution systems.

U.S. Patent Application No. 2005/0114643 discloses a memory device containing data processing applications which execute on a host computer when the device and the computer are operationally connected. The device disclosed in U.S. Patent Application No. 2005/0114643 does not contain digital media for distribution; it merely contains a data processing application to be run on a host computing device. Moreover, the device of U.S. Patent Application No. 2005/0114643 is not suitable for use in a digital media distribution system in accordance with the instant invention. In particular, the portable memory device disclosed in U.S. Patent Application No. 2005/0114643 lacks a means of tying the data on the memory device, the media player, and the memory device together thereby providing a secure means of distributing digital data. As such, the device of U.S. Patent Application No. 2005/0114643 fails to cure the problems associated with current digital media distribution systems.

The current digital media distribution systems, including prior USB-based memory devices, fail to address the needs of both distributors and consumers of digital media. As such, there is a need for a digital media distribution system that reduces piracy, reduces the cost of distribution, is compatible with a large number of devices and is fully integrated.

### SUMMARY OF THE INVENTION

One embodiment of the instant invention encompasses a system that facilitates and controls the distribution of digital media.

Another embodiment of the instant invention encompasses a Digital Rights Management System.

Another embodiment of the instant invention encompasses a system which combines inputs from a media file, identifying information from a USB-based device and/or other identifying information, and an encryption key generator to create output on the USB-based device.

A further embodiment of the instant invention encompasses a system to securely record media files to USB-based memory devices using a Digital Rights Management System, a proprietary and/or linked media player and a file encryption system.

Yet another embodiment of the invention encompasses a device that contains an encrypted file that contains the media data, an executable file that is a media player and a key file that inextricably ties the media data, the media player and the USB device together.

Another embodiment of the instant invention encompasses a digital media distribution system comprising a digital rights management system, identifying information from a USB, encryption key generator information and inputs it into an application that outputs to a USB-based device.

### BRIEF DESCRIPTION OF THE DRAWINGS

FIG. 1 shows the general outline of the components of the system.

FIG. 2 is a description of the Digital Media Distribution Manager (DMDM) application and its component pieces.

FIG. 3 shows a closed system implementation of the DMDM system.

FIG. 4 shows closed system process flow.

FIG. 5 shows open system implementation of the DMDM system.

FIG. 6 shows the process flow of an Open System Implementation of the DMDM System.

FIG. 7 shows pre-processing of a USB flash device for open system implementation or closed system implementation.

FIG. 8 shows media player pre-processing.

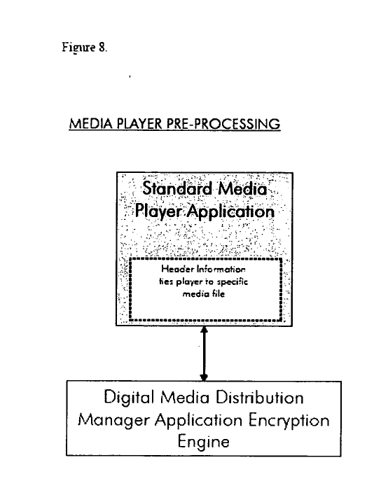

### DETAILED DESCRIPTION OF THE INVENTION

A system that facilitates and controls the distribution of digital media is described. For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented with other systems and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in a certain order, in many instances, these steps may be performed in any order as may be appreciated by one skilled in the art, and the methods are not limited to the particular arrangement of steps disclosed herein.

The present invention provides a Digital Rights Management System to securely record media files to USB-based memory devices using a proprietary or linked media player and a file encryption system. The system is comprised of an application which combines inputs from a media file, identifying information from the USB-based device and/or other identifying information and an encryption key generator to create output on the USB-based device. The output on the device contains an encrypted file that contains the media data, an executable file that is a media player and a key file that inextricably ties the media data, the media player and the USB device together.

The invention provides a efficient and secure means of distributing digital media. The instant invention allows for the secure deployment of digital media by requiring digital media content only to play when combined with a unique/proprietary media player, a specific I/O device and a decryption key. The components, when combined, create a digital rights management system that inextricably ties media content to reusable media. In summary, we have created a platform of copy-proof media on a reusable media device.

The instant invention solves the problem of cost of distribution as it utilizes reusable devices/media and does not rely on 3rd party software for playing the content. The instant system links the reusable device, the content, and the player together to create a system not currently possible with other media. Further, the instant invention addresses the issue of universality by leveraging the largest deployed base of I/O connectivity, the Universal Serial Bus port shipped on 99% of computers and digital devices today. USB ports are low cost and ubiquitous and the system of the instant invention does not require the purchase of any additional hardware or software to operate on a computer or video system with the USB port enabled with standard USB functionality and video capabilities.

The system of the instant invention is fully-integrated so the digital content never leaves the reusable I/O device when played and remains secure. If any of the integrated components is removed, the content is rendered unusable and, therefore, worthless. Beyond a standard USB port and U3 standard functionality, the instant invention does not rely on 3rd party hardware or software to operate. The instant invention combines all of the components in an interdependent, self-contained system making the distribution significantly more secure as the individual parts will not operate if separated. Therefore, the system allows for the secure distribution of media files on reusable devices.

The present invention is especially useful to those in the digital media deployment business. This includes companies operating at different stages of the deployment cycle, from those at the initial deployment stage (such as a movie distribution company) to those interfacing directly with the end-user (such as a retail sales outlet). The target user is interested in protecting the deployment of digital media content, lowering their cost of distribution, and making their content universally playable. The current invention creates an integrated system to accomplish these goals by tying content to a specific USB device that uses U3 compliant technology to play the video natively on the flash drive and does copy/move the content to the host player (i.e. PC, end device, etc.).

Initial deployment stage companies include companies that create the content, such as Sony, Warner Brothers, etc., that will replace current single-use distribution methods (CDs, DVDs) with the more secure digital distribution system disclosed herein. End-user deployment stage companies include companies that direct-sell to the end-user and can leverage the new system for secure, low-cost distribution. The companies typically deal with multiple disadvantages inherent in their distribution methods such as:

Ease of copying and/or complexity of restricting the copying of digital media;

Size of devices used to deploy;

Cost of deployment and devices needed to play media;

Single use nature of devices;

Proprietary formats (i.e. formats not standardized); and

Obsolescence of product.

The system of the instant invention can eliminate existing inventory needs and create new distribution opportunities at brick and mortar companies such as Blockbuster and Hollywood Video; kiosks such as RedBox (McDonalds, MovieStation); and online content providers such as Netflix and Movietime.

The instant invention offers advantages over the prior methods of distributing digital media such as:

This system is more secure that prior methods because of the required interdependence of the media file, media player and device to generate distribution of the media.

This system is more portable (i.e. smaller physical size) than other methods

This system is more universal than other systems as it leverages industry standard hosts for processing, video and audio playback

This system is more efficient than others as it uses USB-based devices for distribution and these devices are generally reusable.

The invention comprises a digital media distribution system consisting of a digital rights management system that utilizes media files, identifying information from a USB drive (such as a serial number), key generator information (i.e. random numbers, other criteria) and inputs it into an application that outputs to a USB-based device. The output from the application on the USB-based device is an encrypted file that contains a data file (the media), an encryption key, and an executable file (a media player) that must be played on the specific device and also require the presence of the specific data file and the encryption key. The data file is stored in a hidden/password protected area of the drive, but may also in other instances require additional security protection (i.e. password, internet connection to a key, etc.). Further, the player is stored on a USB-based device with industry standard software allowing the player to be run natively on the USB drive.

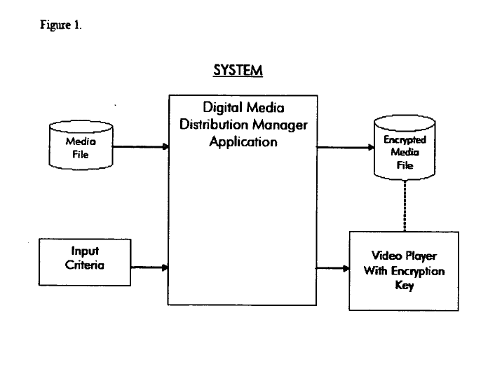

Referring now to the Drawings, FIG. 1 provides a general outline of the components of the system. The largest part of the system is the Digital Media Distribution Application (DMDA”). This application receives the inputs of a media file and some input criteria and outputs an encrypted media file and a media player that is capable of playing the encrypted media file. The encrypted media file and the player are tied together and are reliant on the other to be playable.

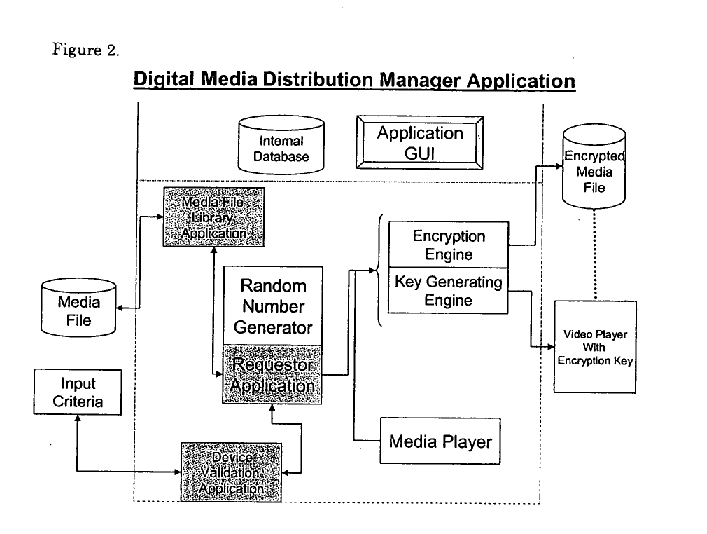

FIG. 2 provides a description of the Digital Media Distribution Manager application and its component pieces. First and foremost, the inputs to the DMDM are a media file and input criteria from a USB device. The media file can be any type of media that can be played by the chosen media player within the DMDM. The input criteria will always contain information that identifies the media that will hold the final output (in our initial product design, this means that the serial number of a USB device and other system information are used to help create the key and so that the media player will function only on that specifically identified device). Within DMDM, there is also a random number generator that can be used to create additional parts of the string for the key generation process. The Requestor Application is the controller that requests media, input criteria and random numbers and delivers them to the encryption engine. The other input to the encryption engine/key generator is the chosen media player. This media player will be assembled with a key that ties the media player to the specific media file and the destination media (in our case a specific and uniquely identifiable USB flash drive). The outputs of the DMDM are the encrypted media file and the media player that can only play the specific file.

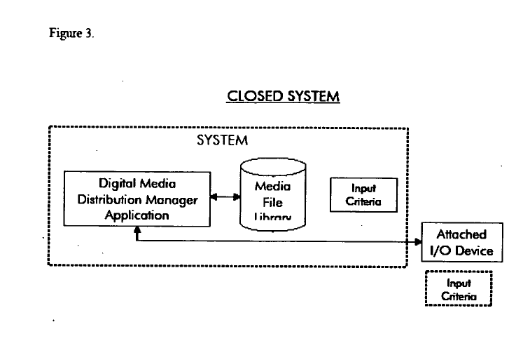

FIG. 3 represents a closed system implementation of the DMDM system. By closed system, we mean that all the operations are undertaken on a single processor of a single system. This type of implementation would work for a brick and mortar rental system where a customer brings a specific Attached I/O Device (in our case a USB Flash Drive) and connects the drive to a system that includes the DMDM Application and the media file library. Also on that system the internal input criteria would come from something like the backplane, HDD serial number, etc. The attached I/O Device would attach via a port across the backplane. The input criteria from the Attached I/O Device would include such things as Serial Number, Manufacturer ID, etc. The DMDA would run and copy the Encrypted Media File and the Media Player with Encryption Key to the Attached I/O device.

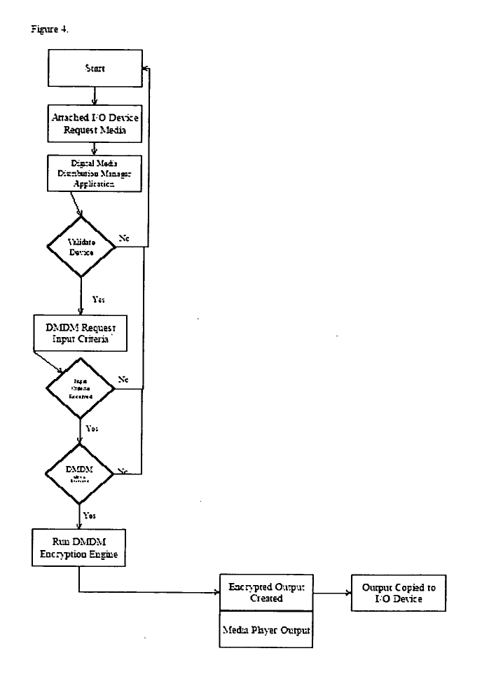

FIG. 4 describes closed system process flow. Application starts on the startup of system device. An I/O Device is attached. The Attached I/O Device user requests media through the Media File Library Application of the DMDM. The DMDM starts up and looks at the Attached I/O Device to validate it is a known device using the Validation Application. If the device is not validated, we return to a start state. If the device is validated, we allow the DMDM to request input criteria. Input Criteria is requested from the device, system and possibly from the Random Number generator. If the input criteria is not received, we return to a start state. If the input criteria is correctly received, the DMDM then requests media from the media library. The media is run through the DMDM Encryption Engine and the Key Generating Application and the Encrypted output is created with a related media player. All output is then copied to the Attached I/O Device.

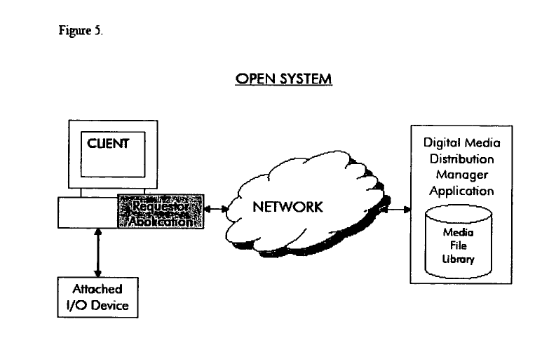

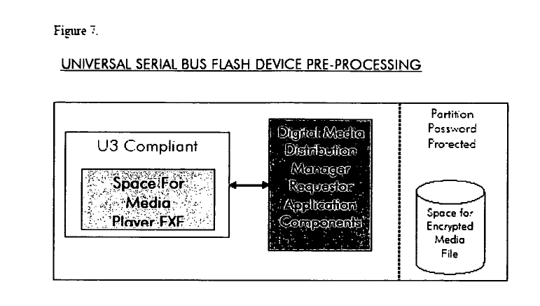

FIG. 5 shows an open system implementation of the Digital Media Distribution Manager System. By open system, we mean that operations are undertaken with the use of both a single system and a network. This drawing shows the client with an Attached I/O Device attached on a network. In this instance, the client of the DMDM System must have part of the Requestor Application of the DMDM System installed on the end system. This can be accomplished by having the application resident on the I/O Device (described in FIG. 7) or by having the client perform an action to download or copy the application from a remote media source (over the internet or other network). In this implementation, an Attached I/O Device attaches to a client where the DMDM Requestor Application is resident or where the Attached I/O Device copies the Requestor Application to the Client. The Client then interfaces with the DMDM over a network, the internet or some similar configuration to request media. The DMDM Application is resident on a system that is accessible through the network and creates an interface to the Media File Library which may or may not be resident on that same system as the DMDM Application. The Media File Library may be on a different system accessible across the network or a system attached directly to the system where the DMDM Application is installed or directly resident on the same system as the DMDM Application.

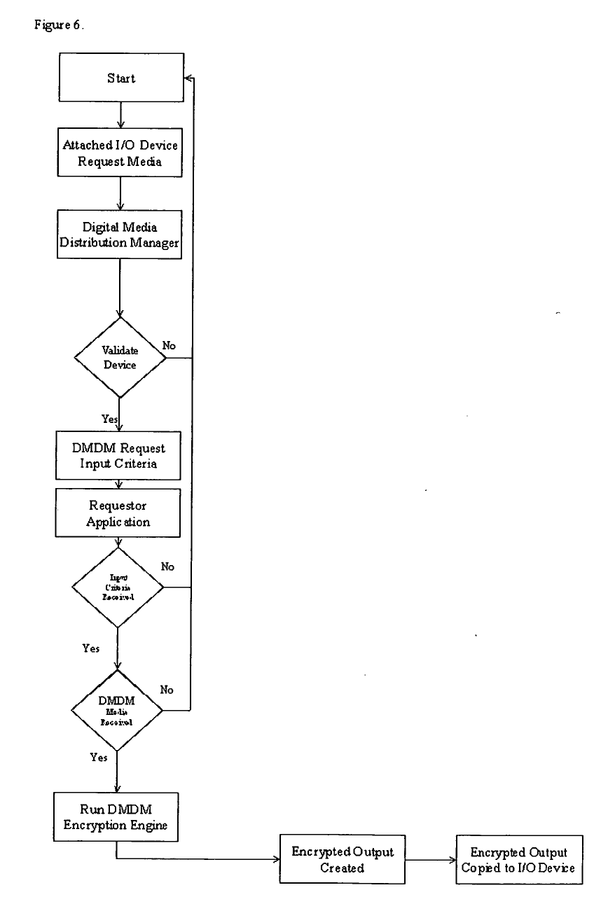

FIG. 6 represents the process flow of an Open System Implementation of the DMDM System. Application starts on the startup of the system/device by the client. An I/O Device is attached. The Attached I/O Device user requests media through the Requestor Application which communicates over the network to the Media File Library Application of the DMDM. The DMDM starts up and sends a request for information about the Attached I/O Device to validate it is a known device using the Validation Application. If the device is not validated, we return to a start state. If the device is validated, we allow the DMDM to request input criteria. Input Criteria is requested from the device, system and possibly from the Random Number generator. If the input criteria is not received, we return to a start state. If the input criteria is correctly received, the DMDM then requests media from the media library. The media is run through the DMDM Encryption Engine and the Key Generating Application and the Encrypted output is created with a related media player. All output is then copied to the Attached I/O Device.

FIG. 7 describes pre-processing of a USB for Open System Implementation or Closed System Implementation. This is an example of the USB Flash Drive pre-processing requirements for the system. This information would be used to pre-process a system's USB devices for use with the DMDM System. First and foremost, in the initial implementation of the system, we foresee using U3 (the U3 Specification is available at www.u3.com) compliant USB devices. To pre-process the USB devices for the system, the USB devices will be attached to a DMDM system and certain identifying information from the device will be copied to the DMDM database for future reference. The USB device will have part of the DMDM Requestor Application copied to it for future use. Finally, a password protected partition will be created on the USB device. The information about that password protected partition will be copied to the DMDM system database for future use.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A digital media distribution system comprising:
a digital rights management system;
identifying information from a portable memory device;
an encryption key generator; and
inputs it into an application that outputs to the portable memory device.

2. The digital media distribution system of claim 1, wherein the portable memory device is a USB-based device.

3. A device for the distribution of digital media comprising:
a means for storing digital media;
unique information that identifies the device; and
an encryption key.

4. The device of claim 3, wherein the device is USB-based.

5. A system for distributing digital media comprising:
an I/O device;
and encryption engine; and
a key generating mechanism.

6. A method of distributing digital media comprising:
attaching an I/O device to a source of digital media;
validating the I/O device;
encrypting the digital media;
downloading the encrypted digital media to the I/O device; and
playing the media only if media is on the I/O device

7. A Digital Rights Management System to securely record media files to USB-based memory devices comprising a proprietary and/or linked media player and a file encryption system.
